(19) United States
(12) Patent Application Publication
(10) Pub. No.: US 2007/0086554 A1
(43) Pub. Date: Apr. 19, 2007

(54) Data synchronizer and data synchronizing method

(75) Inventors: Masashi Tominaga, Kanagawa (JP); Atsunori Takagi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignees: NEC ELECTRONICS CORPORATION, Kawasaki (JP); NEC ENGINEERING, LTD, Tokyo (JP)

(21) Appl. No.: 11/580,029

(22) Filed: Oct. 13, 2006

(30) Foreign Application Priority Data
Oct. 18, 2005 (JP) 2005-302824

(51) Int. Cl. H04L 7/00

(52) U.S. Cl. 375/372

(57) ABSTRACT

According to an embodiment of the present invention, a data synchronizer for outputting data with a readout clock frequency sync with input data or receiving data with a read-in clock frequency sync with output data, includes: a frequency synchronizer controlling a frequency of the readout clock or a frequency of the read-in clock based on an input data amount or output data amount per unit time, the frequency synchronizer controlling the frequency of the readout clock or the frequency of the read-in clock based on a first frequency set value that is preset, before the input data is input or the output data is output.

### BACKGROUND OF THE INVENTION

1. Field of the Invention

The present invention relates to a data synchronizer and a data synchronizing method. In particular, the invention relates to a data synchronizer synchronizing data between devices different in data communication speed or data reproducing or recording speed, and a data synchronizing method.

2. Description of Related Art

In recent years, interfaces conforming to the USB (Universal Serial Bus) standards have been frequently used upon data communications. For example, a sound signal is transmitted/received as digital data through the USB interface, and the sound is reproduced/recorded based on the digital data. In such communications, the sound signal is processed as sampling data that is obtained by digitalizing an analog signal with a predetermined sampling frequency. As an example of the sampling data, PCM (Pulse Code Modulation) data has been known. Such USB devices are, for example, a USB speaker, a USB microphone, and a USB headset obtained by combining a headphone and a microphone. FIG. 9 shows a system where a PC (Personal Computer) 101 is connected with a USB headset (USB device) 103 through a USB cable 102.

In the system of FIG. 9, sound data is transmitted from the PC 101 side to the USB device 103 side through the USB cable 102 to reproduce sounds with the headphone. In addition, sound data taken with the microphone of the headset is transmitted to the PC 101 side through the USB cable 102 to recode the sound data with the PC 101.

In this example, the PC 101 includes a USB host controller, and the USB device 103 includes a USB device controller. The USB host controller issues a command to the USB device controller. The USB device controller controls the USB device 103 based on the command from the USB host controller. Further, the host side transmits/receives user data to/from the device side in accordance with a command from the USB host controller. The user data means data used in a processing of a device requested by a user of the device. For example, the user data is PCM data.

Here, digital sound data such as the PCM data is generally converted from digital signals to analog signals with a DAC (Digital/Analog Converter) and reproduced. In reproducing the sound data, it is necessary to input data to the DAC in sync with a sampling frequency used for recording sounds, and drive the DAC at the sampling frequency.

However, the USB device 103 and the PC 101 transmit/receive data with each other at a USB transfer speed independent of the sampling frequency. This causes a problem in that, if PCM data sent from the PC 101 side through the USB cable 102 is directly reproduced with the DAC, a reproduction frequency is different from a sampling frequency, and the sounds cannot be correctly play reproduced.

Hence, the USB device 103 needs to incorporate a device controller, a data synchronizer, or the like to change data received at the USB transfer speed into data sync with the sampling frequency to reproduce the sounds with the USB device at appropriate speeds. An example of the data synchronizer is disclosed in Japanese Unexamined Patent Publication No. 2001-320351.

FIG. 10 shows a data synchronizer 100 as disclosed in Japanese Unexamined Patent Publication No. 2001-320351. As shown in FIG. 10, the data synchronizer 100 includes a FIFO 111, a buffer 112, a CPU 113, a ROM 114, a 1/N divider 115, and an external fixed oscillator 116. The data synchronizer 100 temporarily accumulates input data Di from the PC side in the FIFO 111, and outputs data Do sync with a sampling clock Fs to the USB device side through the buffer 112.

A flow of determining a sampling clock frequency of the data synchronizer 100 is explained below. First, in general, the host controller transmits/receives sync signals called SOF (Start of Frame) packets to/from the device controller at intervals of 1 msec or 125 μsec. Thus, communicating operations are synchronized. Further, a period from one SOF packet to the next SOF packet is defined as one frame. The host controller and the device controller divide data so that the divided data following the SOF packet falls within one frame, and successively transmit/receive the frame.

Description is given next of a processing flow from when the PC 101 is connected with the USB device 103 based on the frame-based communications until when the USB device 103 starts operating. An upper portion of FIG. 11 shows a frame flow from the connection with the USB device 103 until the start of sound data communication. As shown in the upper portion of FIG. 11, when the USB device 103 is connected at time t0, several frames of SOF packets are transmitted. After that, device authenticating control data RD for device authentication is transmitted/received at time t1. After the completion of the device authentication, device setting control data CD for setting a controlling method of the USB device is transmitted/received at time t2. After the completion of setting the controlling method of the device, sound data AD as user data is transmitted/received at time t3. From time t3 onward, sound data can be output from a headphone of the USB device 103, for example.

The data synchronizer 100 determines a divider value N based on sound data AD from time t3 forward. A lower portion of FIG. 11 shows a change in divider value N. The divider value N of the data synchronizer 100 is kept at an initial value until time t3. From time t3 forward, the divider value is adjusted based on the sound data AND. If the divider value N has not been changed for a predetermined period, the divider value N is fixed (locked) after the period. A frequency of a sampling clock Fs is determined by dividing a clock frequency ExCLK of the external fixed oscillator 116 with the divider value N.

A method of adjusting the divider value N is described below. Each time the SOF is input from the PC 101 side, the CPU 113 monitors a free space of the FIFO 111 to determine the divider value N so that the free space of the FIFO 111 falls within a predetermined range. That is, the data synchronizer 100 adjusts the divider value N so that the free space of the FIFO 111 falls within a predetermined range, and finally locks the divider value N. Further, an output signal Do is output in sync with the sampling clock Fs the frequency of which is determined in accordance with the divider value N, and thus the data synchronizer 100 can output the sound data AND accumulated in the FIFO 111 at the sampling frequency of the sound data AD.

By adjusting the divider value N this way, the data synchronizer 100 can output data in accordance with input sound data of different sampling frequencies.

However, the data synchronizer 100 disclosed in Japanese Unexamined Patent Publication No. 2001-320351 adjusts the divider value N after receiving the sound data. Accordingly, the divider value just after received cannot be adapted to the sampling frequency of the input sound data. Thus, the sampling frequency varies during a period just after the start of receiving the sound data until when the divider value N becomes adapted to the sampling frequency. This causes a problem in that a reproducing speed of the sound data is unstable, and the sound quality deteriorates during a period just after the start of receiving the sound data until when the sampling frequency is stabilized.

### SUMMARY OF THE INVENTION

According to an aspect of the present invention, a data synchronizer for outputting data with a readout clock frequency sync with input data or receiving data with a read-in clock frequency sync with output data, includes: a frequency synchronizer controlling a frequency of the readout clock or a frequency of the read-in clock based on an input data amount or output data amount per unit time, the frequency synchronizer controlling the frequency of the readout clock or the frequency of the read-in clock based on a first frequency set value that is preset, before the input data is input or the output data is output.

According to the data synchronizer of the present invention, a frequency of a clock is controlled based on the preset first frequency set value, before the input data is input or the output data is output. Hence, a frequency of the readout clock or read-in clock at the start of inputting the input data or outputting the output data can be close to a frequency corresponding to a data amount of the input data or output data. Further, after the start of inputting the input data or outputting the output data, the readout clock or read-in clock is controlled based on the data amount of the input data or output data, whereby the frequency of the readout clock or read-in clock can correspond to the data amount of the input data or output data. That is, the data synchronizer according to the present invention can reduce a period in which a clock frequency after the start of inputting the input data or outputting the out data is unstable, as compared with a conventional data synchronizer. Hence, if sound data is output or input, for example, such period that sound quality deteriorates in a control period thereof can be shortened.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a USB device according to a first embodiment of the present invention;

FIG. 2 shows an example of packet transmission/reception on a USB bus;

FIG. 3 shows an example of a packet data format conforming to the USB standards;

FIG. 4 is a flowchart of operations of a data synchronizer of the first embodiment;

FIG. 5 is a flowchart of an operation of determining a readout clock frequency based on a temporary sampling frequency of the data synchronizer of the first embodiment;

FIG. 6 shows a flow of data input to the data synchronizer of the first embodiment and a change in readout clock frequency;

FIG. 7 is a block diagram of a USB device according to a second embodiment of the present invention;

FIG. 8 shows a flow of data output from a data synchronizer of the second embodiment and a change in readout clock frequency;

FIG. 9 shows a system example using a general USB device;

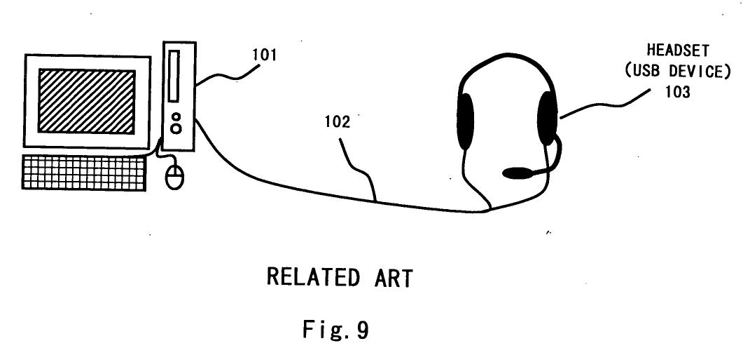

FIG. 10 is a block diagram of a conventional data synchronizer; and

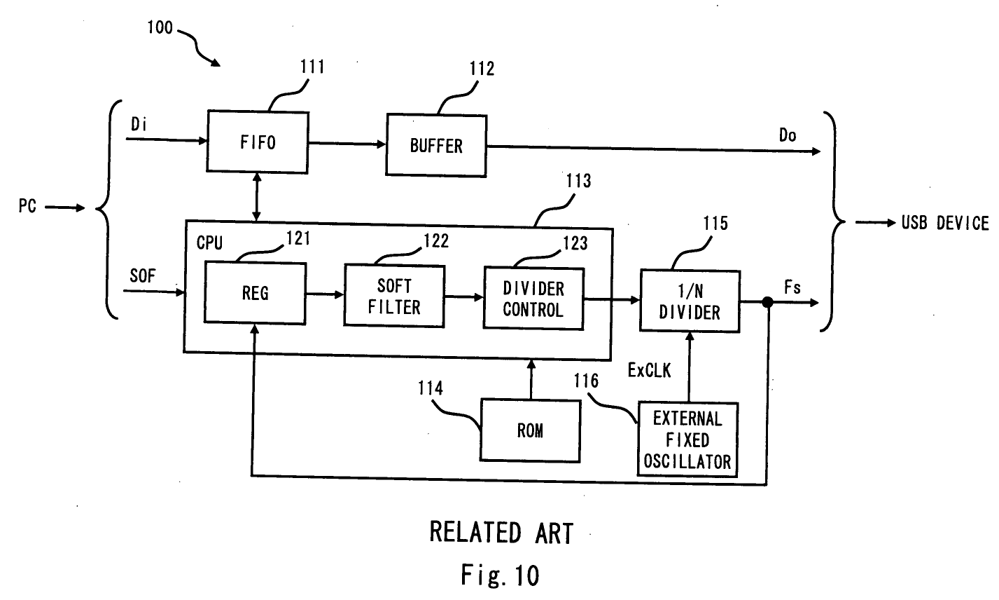

FIG. 11 shows a flow of data input to the conventional data synchronizer and a change in readout clock frequency.

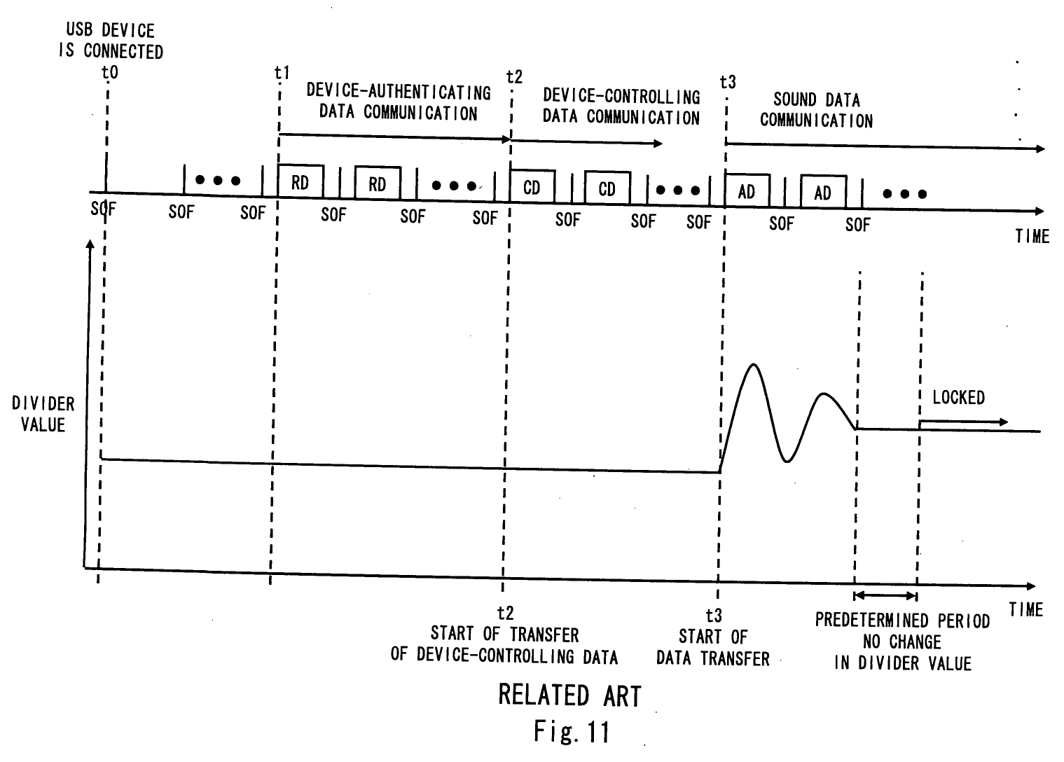

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

First Embodiment

Hereinafter, a first embodiment of the present invention will be described with referent to the accompanying drawings. Incidentally, in the following description about embodiments of the present invention, hardware components are used, but the present invention is not limited thereto. The present invention may be embodied using firmware or software components. Further, the present invention is not limited to the following embodiments and can be appropriately modified.

A data converter of this embodiment communicates with an external device based on a predetermined protocol. For example, the data converter is a USB device (for example, speaker) 1 that communicates with an external device (for example, PC) based on a protocol of the USB standards. The USB device 1 includes a terminal communicating with a PC based on the protocol of the USB standards (for example, USB terminal), and is connected with the PC through a USB cable connected with the USB terminal. The PC transmits serial periodic data, for example, sound data sampled at a predetermined sampling frequency and system data used for authenticating or controlling the USB device 1 (for example, control data), to the USB device 1. The USB device 1 reproduces input sound data in accordance with the sampling frequency, based on the settings of the control data.

Here, the serial periodic data is PCM data obtained by sampling sounds at a predetermined sampling frequency, for example. The data is sequential data of a predetermined cycle like the sampling frequency. As for this data, a predetermined amount of data is input within unit time. For example, if a stereo sound of 16-bit resolution (2 ch) is sound data recorded at the sampling frequency of 44.1 kHz, data of 441×2×2 bytes is input within 10 msec. That is, if an amount of data received within unit time and the channel number are known, the sampling frequency can be calculated.

First, description is made of data transmitted/received between the PC and the USB device 1. Upon the communications based on the USB standards, for example, signals of the USB format are transmitted/received between a host controller mounted to the PC and a device controller mounted to the USB device 1. The USB standards define four data transfer modes: a controlled transfer mode, a bulk transfer mode, an interrupt transfer mode, and an isochronous transfer mode. In this embodiment, in the case of the control data communications, the controlled transfer mode is mainly used. In the case of the sound data communications, the isochronous transfer mode is mainly used. In the controlled transfer mode, bidirectional communications that make a request and a response out of non-periodic communications are executed. In the isochronous transfer mode, serial periodic data is transmitted/received. The isochronous transfer mode is used for, for example, the real time transfer of sound data or the like.

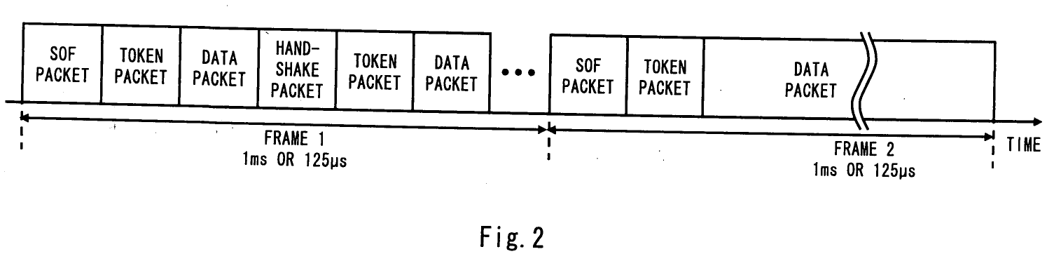

FIG. 2 shows an example of packet communications on the USB bus. As shown in FIG. 2, SOF (Start of Frame) packets are transferred from the host controller to the device controller on the USB bus at intervals of 1 msec in the case of USB 1.1 format and at intervals of 125 μsec in the case of USB 2.0 format. The USB standards define a period from one SOF packet to the next SOF packet as one frame.

On the USB bus, the data is transmitted on a frame basis, and various types of packets are transmitted after the SOF packet. FIG. 2 shows an example where a frame 1 is control data, and frame 2 is sound data. As for the control data, following the SOF packet, a token packet, a data packet, a handshake packet, a token packet, and a data packet are transmitted. As for the sound data, following the SOF packet, a token packet and a data packet are transmitted.

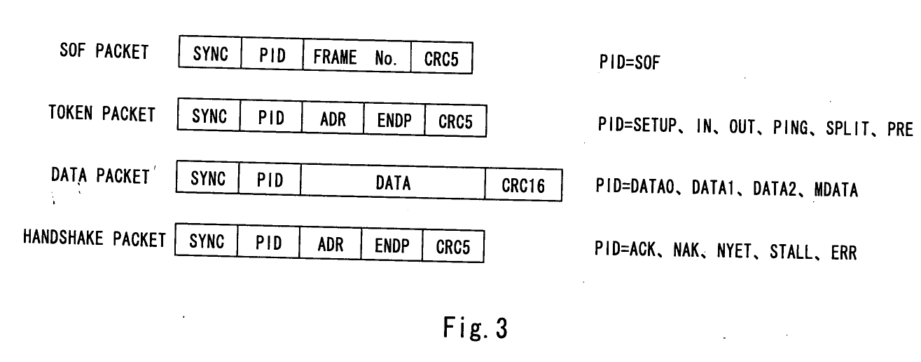

Here, the above packets are described in detail. FIG. 3 shows an example of the packet data. A SYNC area is provided at the head of each packet, and the operations of the host controller and the device controller are synchronized using the area. A PID area for authenticating each packet follows the SYNC area, and areas subsequent to the PID area differ from one packet to another.

In the SOF packet, a SOF command is described in the PID area to indicate the start of a frame. Further, in an area following the PID area of the SOF packet, the frame number and CRC (Cyclic Redundancy Check) are described.

In the token packet, a SETUP command, an IN command, an OUT command, a PING command, a SPLIT command, or a PRE command is described in the PID area. The SETUP command makes the host controller control the device controller. The IN command makes the device controller transfer data to the host controller. The OUT command designates a controlled transfer mode. Further, the PING command is to check the USB device state, and the SPLIT command designates a low-speed data transfer mode (split transaction) if communications are executed at plural transfer speeds. The PRE command designates a low-speed packet in the split transaction. An address (ADR) area, an end point (ENDP) area, and a CRC area follow the PID area. The address (ADR) is to designate an address of the device controller. The end point (ENDP) is a data buffer in the device controller for data transfer between the host controller and the device controller.

In the PID area of the data packet, a value for checking a data loss is described. In the data area, data processed by the device controller is described. In an area following the data area, the CRC (CRC result) is described.

In the handshake packet, a response command from the device controller to the host controller such as ACK or NAK is described in the PID area. Further, the address, the end point, and the CRC are described in the PID area similar to the token packet.

As described above, in the communications with the USB interface, the sound data is transmitted/received at a predetermined transfer speed (for example, communication speeds based on the USB standards) independent of the sampling frequency of the sound data. Thus, the sound data received by the device controller should be converted from digital signals to analog signals based on the sampling frequency of the sound data. The data synchronizer 10 of the USB device 1 of this embodiment output data while synchronizing a frequency of the input data with a readout clock. For example, the data synchronizer receives a predetermined amount of input data (for example, sound data) within a predetermined period at a transfer speed conforming to the USB standards, and outputs the sound data in sync with the sampling frequency extracted from the sound data. Further, the sound data output from the data synchronizer 10 is converted into analog signals by a first converter (for example, digital/analog converter (DAC)) 30. In this way, the USB device 1 of this embodiment reproduces the received sound data of the USB format.

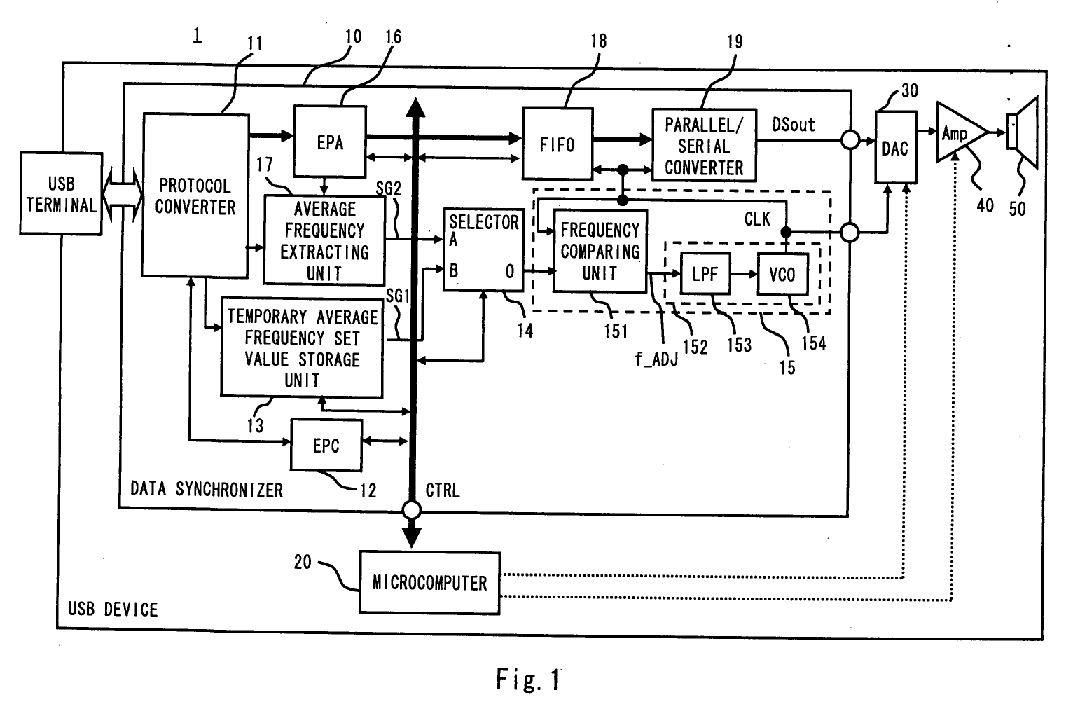

The USB device 1 is described in detail with reference to FIG. 1. The USB device 1 includes the data synchronizer 10, microcomputer 20, a DAC 30, an amplifier 40, and a speaker 50.

The data synchronizer 10 is a block that transmits control data input through the USB cable to the microcomputer 20, and generates a sampling clock (for example, readout clock) having a frequency based on a sampling frequency extracted from the received sound data to output the readout clock and the sound data sync with the readout clock. Detailed description about the data synchronizer 10 is given below.

The microcomputer 20 is a block controlling the data synchronizer 10, the DAC 30, and the amplifier 40 based on the control data. The DAC 30 is a block operating with the readout clock, and converting a digital signal DSout output from the data synchronizer 10 into an analog signal to output the converted signal. The amplifier 40 is a circuit amplifying the analog sound signal output from the DAC 30 and driving the connected speaker 50.

The data synchronizer 10 is described in detail. The data synchronizer 10 includes a protocol converter 11, an end point C (EPC) 12, a temporary average frequency set value storage unit 13, a selector 14, a frequency synchronizer 15, an end point A (EPA) 16, an average frequency extracting unit 17, a storage unit (for example, FIFO) 18, and a parallel/serial converter 19.

The protocol converter 11 analyzes signals of the USB format input from the USB terminal, and transmits the data to a corresponding end point block with reference to the analyzed data. The EPC 12 receives the control data out of the input data, and notifies the microcomputer 20 of control operations in accordance with the control data.

The temporary average frequency set value storage unit 13 is a block storing, for example, a first frequency set value (for example, temporary average frequency set value) SG 1. The temporary average frequency set value SG 1 is to designate a predetermined frequency. For example, the temporary average frequency set value SG 1 is set such that a difference between the frequency of the readout clock CLK and the sampling frequency of the sound data falls within a predetermined range. The temporary average frequency set value SG 1 is a pulse signal of a predetermined cycle which is generated by counting the sound data by an average data amount per unit time. Further, the temporary average frequency set value SG 1 is a value preset in the temporary average frequency set value storage unit 13 or a value supplied from the outside of the data synchronizer 10. The temporary average frequency set value SG 1 is not limited to one set value. It is possible to prepare plural set values and determine which value is used based on the control data. The data synchronizer 10 controls the frequency of the readout clock CLK generated with the frequency synchronizer 15 in such a period that no sound data is input, based on the temporary average frequency set value SG 1.

The average frequency extracting unit 17 calculates an average data amount per unit time of sound data in the EPA 16, and outputs a second frequency set value (for example, average frequency set value) SG 2 as a value corresponding to the sampling frequency derived from the data amount and as a source of a frequency of the readout clock CLK. The average frequency set value is a pulse signal of a predetermined cycle corresponding to the sampling frequency that is extracted by counting a data amount of sound data. That is, while the temporary average frequency set value SG 1 is a virtual frequency set value of the readout clock CLK, the average frequency set value SG 2 is a frequency set value of the readout clock CLK in accordance with actually received sound data.

Here, since the sampling frequency of input sound data is generally limited to a predetermined range, the average frequency set value SG 2 is also within a predetermined frequency range. Thus, the temporary average frequency set value SG 1 may be set such that a difference from the average frequency set value SG 2 falls within a predetermined range. For example, assuming that the sampling frequency of the sound data ranges from 32 kHz to 48 kHz, a predetermined range is 8 kHz, so the temporary average frequency set value SG 1 can be set to 40 kHz.

The selector 14 selects and outputs the temporary average frequency set value SG 1 or the average frequency set value SG 2. This selection is carried out based on signals sent from the microcomputer through the bus. During a period in which no sound data is input, the temporary average frequency set value SG 1 is selected. During a period in which sound data is input, the average frequency set value SG 2 is selected.

The frequency synchronizer 15 includes a frequency comparing unit 151 and a clock generator 152. The frequency comparing unit 151 outputs a frequency control signal f_ADJ based on a frequency difference between the temporary average frequency set value SG 1 or average frequency set value SG 2 selected by the selector 14 and the readout clock CLK generated with the clock generator 152. The frequency control signal f_ADJ is a pulse signal the duty ratio of which is changed based on a frequency difference between the temporary average frequency set value SG 1 or the average frequency set value SG 2, and the readout clock CLK. In addition, if the frequency of the readout clock CLK is higher than the frequency of the temporary average frequency set value SG 1 or the average frequency set value SG 2, a high-level period of the pulsed frequency control signal f_ADJ is set short (duty ratio is set low). If the frequency is lower, a high-level period of the pulsed frequency control signal f_ADJ is set long (duty ratio is set high).

The clock generator 152 is a block generating a readout clock the frequency of which varies depending on the duty ratio of the frequency control signal f_ADJ, for example. In this embodiment, the clock generator 152 includes a low-pass filter (LPF) 153 and a voltage-controlled oscillator (VCO) 154. The clock generator 152 generates a DC voltage where the frequency control signal f_ADJ is filtered and smoothed with the LPF 153, and the VCO 154 generates the readout clock CLK of a frequency corresponding to the DC voltage level.

In this embodiment, during a period in which no sound data is input, the frequency comparing unit 151 outputs the frequency control signal f_ADJ corresponding to a frequency difference between the temporary average frequency set value SG 1 and the readout clock CLK. During a period in which the sound data is input, the frequency comparing unit 151 outputs the frequency control signal f_ADJ corresponding to a frequency difference between the average frequency set value SG 2 and the readout clock CLK. The clock generator 152 generates a readout clock CLK of a frequency corresponding to the duty ratio of the frequency control signal f_ADJ. That is, the frequency comparing unit 151 controls the frequency control signal f_ADJ to eliminate a frequency difference between the readout clock CLK and the temporary average frequency set value SG 1 or the average frequency set value SG 2. Hence, during a period in which no sound data is input, the frequency of the readout clock CLK is sync with the temporary average frequency set value SG 1. During a period in which the sound data is input, the frequency of the readout clock CLK is sync with the average frequency set value SG 2.

The EPA 16 sends the received sound data to the FIFO 18. The FIFO 18 is a first-in first-out memory operating in sync with a readout clock CLK, and is a block temporarily storing sound data. The parallel/serial converter 19 is a block that reads the sound data from the FIFO 18 as parallel data, and converts the read data into serial data to output the data in sync with the readout clock CLK.

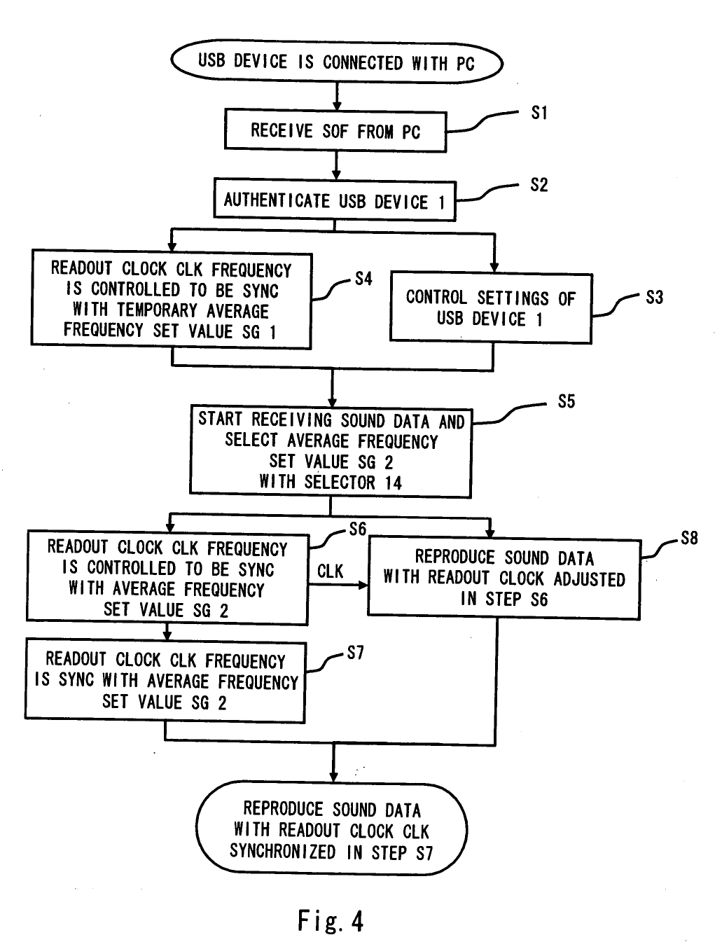

FIG. 4 is a flowchart of operations of the data synchronizer 10. Referring to FIG. 4, the operations of the data synchronizer 10 are described. First, when the USB device 1 is connected with the PC, the USB device 1 starts operating. After the USB device 1 is connected with the PC, the PC transmits several frames not including control data or sound data to the USB device 1 (step S1). The communications of step S1 are performed based on, for example, the USB standards, and continued for several hundreds of msec after the PC is connected with the USB device 1. Subsequently, when the PC transmits frames including the device authenticating control data RD to the USB device 1, the USB device 1 executes device authentication on the PC. At this time, the USB device 1 transmits information on the sampling frequency applicable to the device, to the host side (step S2).

After the completion of the processing of step S2, the PC transmits device setting control data CD to the USB device 1, and the USB device 1 sets operations of each block of the USB device 1 in accordance with the device setting control data CD (step S3). Through the communications of step S3, the host side sends information about the temporary average frequency set value SG 1 to the device side. The information on the temporary average frequency set value SG 1 is processed at the beginning of step S3.

Further, if receiving the information on the temporary average frequency set value SG 1 upon the communications of step S3, the USB device 1 performs control such that the frequency of the readout clock CLK is sync with the temporary average frequency set value SG 1, in parallel with the operation of step S3 (step S4). The operation of step S4 is described in detail below.

After the completion of the operation of step S3, in response to the transmission of sound data from the PC to the USB device 1, the USB device 1 starts receiving the sound data. Further, the selector 14 of the data synchronizer 10 switches a selected signal from the temporary average frequency set value SG 1 to the temporary average frequency set value SG 2 (step S5). When the USB device 1 receives the sound data, the average frequency extracting unit 17 extracts the average frequency set value SG 2 from the sound data. The average frequency set value SG 2 is input to the frequency comparing unit 151 through the selector 14. That is, from step S5 forward, the frequency comparing unit 151 changes the frequency control signal f_ADJ based on a frequency difference between the readout clock CLK and the average frequency set value SG 2 in place of the temporary average frequency set value SG 1. Thus, the frequency of the readout clock CLK is sync with the average frequency set value SG 2 under the control (step S6). The readout clock CLK controlled in step S6 becomes a clock of a frequency sync with the average frequency set value SG 2 (step S7).

Further, even in a period from step S6 to step S7, in which the readout clock CLK is controlled, the USB device 1 reproduces the sound data with the readout clock CLK controlled (step S8). After the frequency of the readout clock CLK is stabilized at step S7, the sound data is reproduced based on the readout clock CLK having a frequency sync with the average frequency set value SG 2.

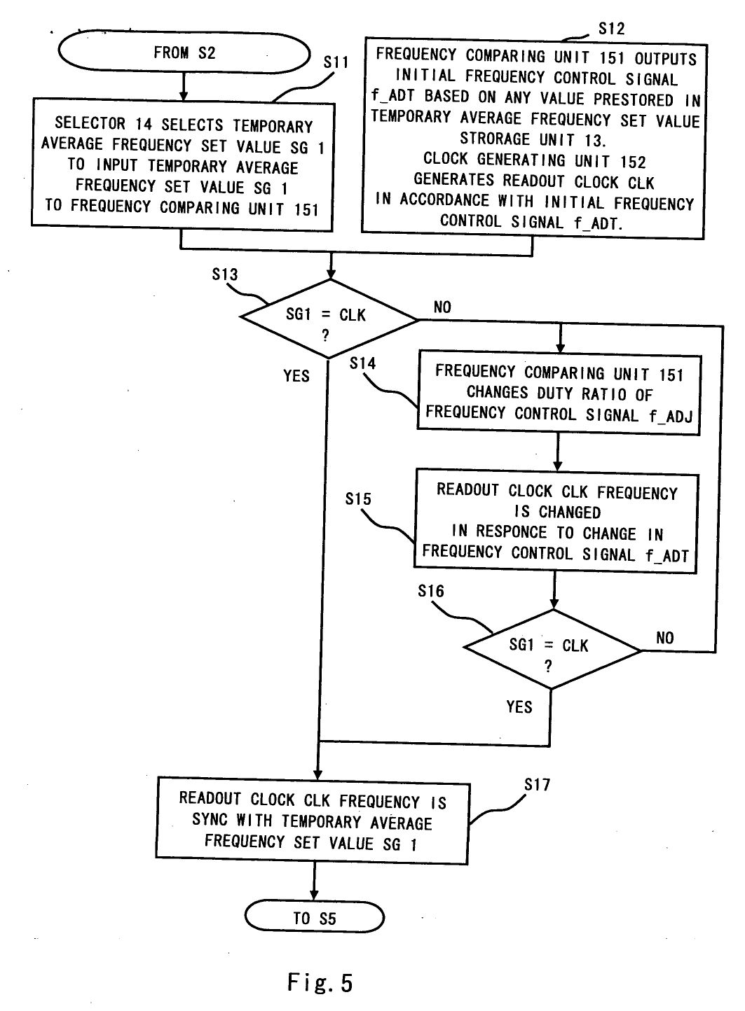

Here, detailed description is given of a flow of controlling the frequency of the readout clock CLK based on the temporary average frequency set value SG 1 in step S4. FIG. 5 is a detailed flowchart of step S4. As shown in FIG. 4, the operation of step S4 is started after the completion of the operation of step S2. In step S4, after the completion of the operation of step S2, the temporary average frequency set value SG 1 that is set under the control of the host is input to the frequency comparing unit 151 (step S11). At this time, the frequency comparing unit 151 outputs the initial frequency control signal f_ADJ that is based on any value prestored in the temporary average frequency set value storage unit 13, and the clock generator 152 generates the readout clock CLK of a frequency corresponding to the initial frequency control signal f_ADJ (step S12). Here, the initial frequency control signal f_ADJ may be determined based on the specifications of a product or settings at the design stage.

After that, the temporary average frequency set value SG 1 and the readout clock CLK are input to the frequency comparing unit 151. The frequency comparing unit 14 compares the temporary average frequency set value SG 1 with the frequency of the readout clock CLK to determine whether or not the two frequencies match with each other (step S13). If it is determined in step S13 that the frequencies of the two signals match with each other, the frequency of the readout clock CLK is stabilized as the frequency sync with the temporary average frequency set value SG 1 (step S17).

Further, it is determined in step S13 that the frequencies of the two signals do not match with each other, the frequency comparing unit 15 changes the duty ratio of the frequency control signal f_ADJ base on a frequency difference between the two signals (step S14). Subsequently, the clock generator 152 changes a frequency of the readout clock CLK in accordance with the change in frequency control signal f_ADJ (step S15).

After that, the frequency comparing unit 151 compares the temporary average frequency set value SG 1 and the readout clock CLK changed in a period from step S14 to step S15 to determine whether or not the frequencies of two signals match with each other (step S16). If it is determined in step S16 that the frequencies of two signals match with each other, the frequency of the readout clock CLK is sync with the temporary average frequency set value SG 1 (step S17). Further, if it is determined in step S16 that the frequencies of two signals do not match with each other, the operations of step S14 to step S16 are repeatedly executed.

In step S17, if the USB device 1 starts receiving the sound data, the flow advances to step S5. Although not shown in the flowchart of FIG. 5, the operation of step S4 is completed at the completion of the control settings of the USB device 1 in step S3.

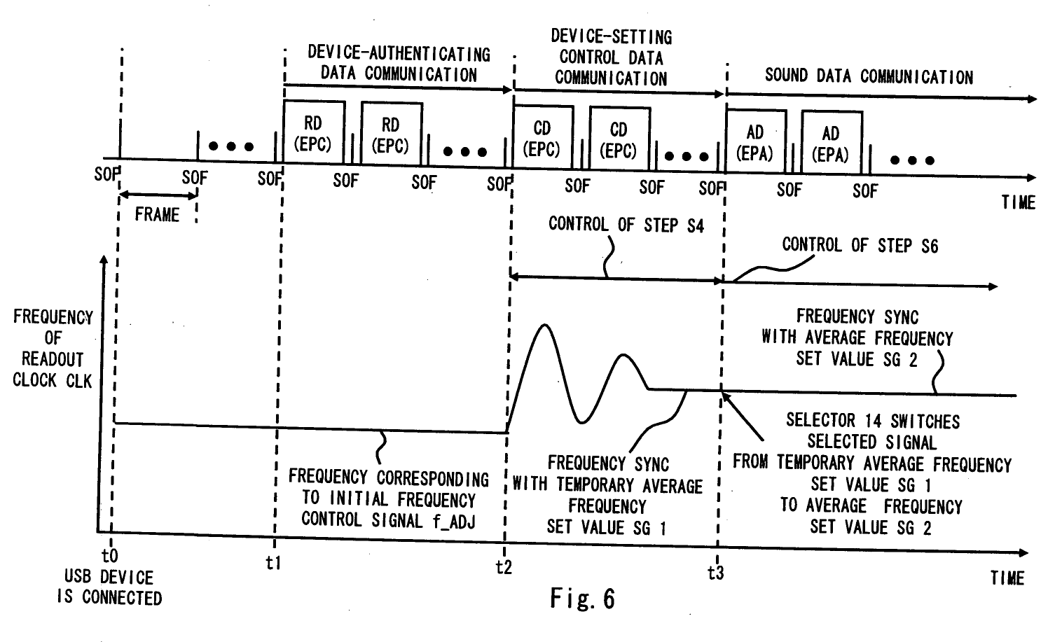

The operations of the flowchart of FIG. 4 are described with reference to FIG. 6 showing a flow of frames transmitted/received between the PC and the USB device 1 and the change with time in frequency of the readout clock CLK. As shown in FIG. 6, when the PC and the USB device 1 are connected at time t0, several frames including no data are transmitted/received (step S1 of FIG. 4). Thereafter, during the first period (period from time t1 to time t2), the device authenticating control data RD designating the EPC 12 is transmitted/received to authenticate the USB device 1 (step S2 of FIG. 4). At this time, the USB device 1 sends information about the sampling frequency adaptive to the device, to the host side. In addition, the frequency of the readout clock CLK corresponds to the initial frequency control signal f_ADJ.

Subsequently, during the second period (period from time t2 to time t3), the PC transmits the device setting control data CD designating the EPC 12 to the USB device 1 for control settings of the USB device 1 (step S3 of FIG. 4). Incidentally, in this embodiment, through the control settings, the USB device 1 determines the temporary average frequency set value SG 1 so that the frequency of the readout clock CLK is sync with the temporary average frequency set value SG 1 under the control (step S4 of FIG. 4). Incidentally, it is more preferred to start the control of the frequency of the readout clock CLK based on the temporary average frequency set value SG 1, after the USB device 1 is connected with the PC at time to, and then it is confirmed that the reception state of the SOF packets is normal and that enough current is supplied to the USB device 1, irrespective of the reception period of the device setting control data CD.

After the completion of control settings of the USB device 1 at time t3, the PC sends sound data designating the EPA 16 to the USB device 1 (step S5 of FIG. 4). At this time, the selector 14 of the data synchronizer 10 switches the selected signal from the temporary average frequency set value SG 1 to the average frequency set value GS2. As a result, in a third period (from time t3 forward), the frequency of the readout clock CLK is sync with the sampling frequency of sound data, and the sound data is reproduced in accordance with the sampling frequency of the sound data (from step S6 to step S7 of FIG. 4).

As understood from the above description, the data synchronizer 10 of this embodiment executes control such that the frequency of the readout clock CLK is sync with the temporary average frequency set value SG 1 close to the average frequency set value SG 2, in the reception period of the device setting control data before the start of receiving the sound data. After that, when starting the reception of the sound data, the data synchronizer 10 synchronizes the readout clock CLK with the average frequency set value SG 2 corresponding to the sampling frequency derived from a data amount per unit time of the received sound data. Here, the frequency of the readout clock CLK just after the USB device 1 starts receiving the sound data is set to a frequency close to the sampling frequency of the received sound data under the control, by controlling the frequency based on the temporary average frequency set value SG 1 before the sound data is received. Thus, in the data synchronizer 10 of this embodiment, the frequency of the readout clock CLK does not largely change between before and after the sound data is received. That is, in the conventional data synchronizer, after the reception of the sound data, the frequency of the readout clock largely changes, and the sound quality deteriorates. In contrast, the data synchronizer 10 of this embodiment can largely reduces a period in which the sound quality deteriorates after the sound data is received.

Further, the data synchronizer 10 of this embodiment derives the average frequency set value SG 2 from the data amount per unit time of the received sound data, and a frequency of the readout clock CLK after the reception of the sound data can be sync with the average frequency set value SG 2. Thus, even if the sampling frequency of the sound data transmitted from the PC varies, the data synchronizer 10 of this embodiment can generate the readout clock CLK sync with the sampling frequency of the sound data to reproduce the sound data at optimum speeds.

Further, according to the data synchronizer 10 of this embodiment, the frequency of the readout clock CLK is controlled before the reception of the sound data, so even if a control period of the frequency of the readout clock CLK is long, the readout clock frequency is not largely changed after the sound data is received. That is, according to the data synchronizer 10 of this embodiment, it is possible to significantly suppress an influence of variations in elements constituting the clock generator 152 on the control period of the frequency of the readout clock. The control period of the frequency of the readout clock CLK may increase due to, for example, the variations in clock generator 152. If the clock generator 152 involves the variations, the initial frequency value of the readout clock CLK is largely different from an intended frequency. As a result, the frequency variation range is widened in the control operation, and the control period is lengthened. The variations occur due to, for example, variations in elements composing the clock generator 152 or a change in element characteristics due to an ambient temperature change.

In the above first embodiment, after time t3 of FIG. 6, the frequency of the readout clock CLK is controlled based on the average frequency set value SG 2 derived from the received sound data. However, the frequency of the readout clock CLK may be controlled in consideration of a memory space of the FIFO 18.

Second Embodiment

While the USB device 1 of the first embodiment reproduces sounds, a USB device 2 according to a second embodiment of the present invention reproduces and records sounds. Reproducing components of the USB device 2 are the same as the USB device 1 of the first embodiment, and thus designated by identical reference numerals, and description thereof is omitted here.

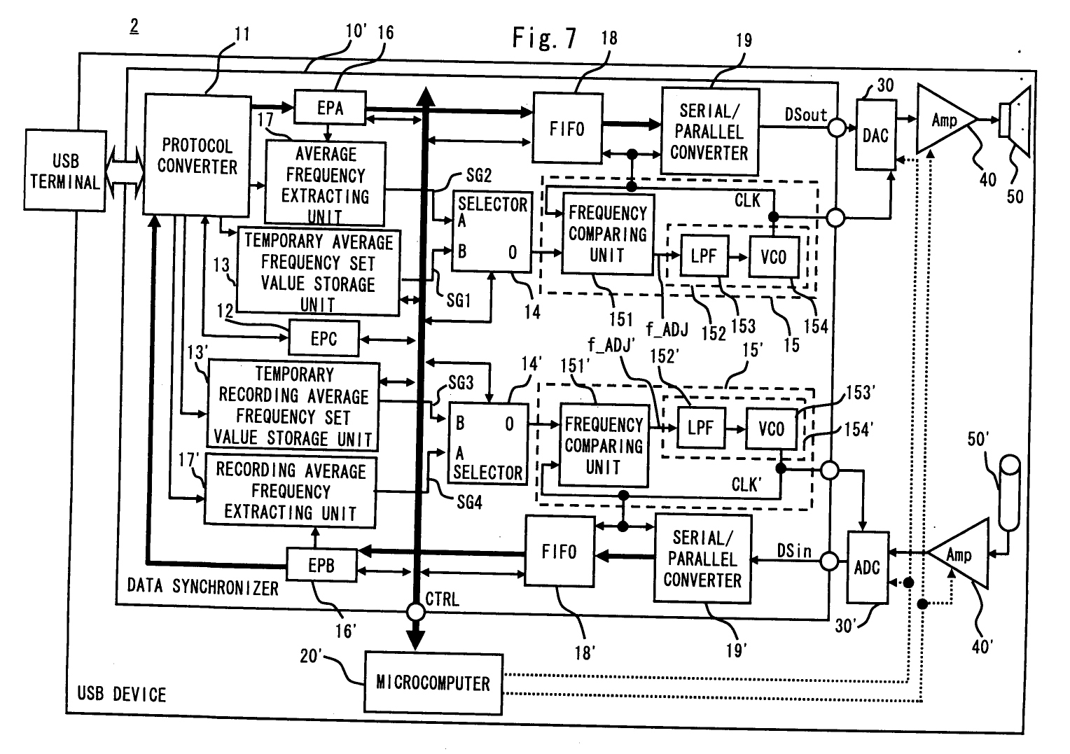

Hereinafter, recording components of the second embodiment are described with reference to the drawings. FIG. 7 shows the USB device 2 of the second embodiment. As shown in FIG. 7, the USB device 2 of the second embodiment includes a USB terminal, a data synchronizer 10′, a microcomputer 20′, the first converter (for example, DAC) 30, a second converter (for example, ADC (Analog Digital Converter)) 30′, amplifiers 40, 40′, the speaker 50, and an amplifier 50′. In this example, the DAC 30, the amplifier 40, and the speaker 50 are the same as the first embodiment.

In addition to the functions of the data synchronizer 10 of the first embodiment, the data synchronizer 10′ is a block generating a read-in clock CLK′ of a predetermined recording sampling frequency for sampling sound data based on control data input through the USB cable to fetch the sound data from the amplifier 50′ based on the read-in clock CLK′ to send output data (for example, recorded data) to the PC. For example, the data synchronizer 10′ adjusts the read-in clock CLK′ such that the read-in clock CLK′ corresponds to a data amount read out from the USB within a predetermined period, converts the sound data, and outputs the sound data as recorded data to the PC. Detailed description about the data synchronizer 10′ is given later.

The microcomputer 20′ is a block controlling the data synchronizer 10′, the DAC 30, the ADC 30′, and the amplifiers 40, 40′ based on the control data. The ADC 30′ is a block operating with the read-in clock CLK′, and converting analog signals output from the amplifier 40′ into digitalized data DSin based on the read-in clock CLK′ to output the converted data. The amplifier 40′ amplifies the analog signals output from the amplifier 50′ to transmit the signals to the connected ADC 30′.

The data synchronizer 10′ is described in detail. The data synchronizer 10′ includes a temporary recording average frequency set value storage unit 13′, a selector 14′, a frequency synchronizer 15′, an end point B (EPB) 16′, a recording average frequency extracting unit 17′, a FIFO 18′, and a serial/parallel converter 19′, in addition to components of the data synchronizer 10 of the first embodiment.

The temporary recording average frequency set value storage unit 13′ is a block storing the first frequency set value (for example, temporary recording average frequency set value) SG 3 that is previously designated based on the control data or preset, for example. The temporary recording average frequency set value SG 3 is a value corresponding to the temporary average frequency set value SG 1 of the first embodiment, and is a pulse signal corresponding to a sampling frequency derived from the average data amount per unit time of the received sound data.

The recording average frequency extracting unit 17′ calculates an average data amount per unit time of sound data in the EPB 16′, and outputs a second frequency set value (for example, recording average frequency set value) SG 4 as a value corresponding to the sampling frequency derived from the data amount and as a source of a frequency of the readout clock CLK (as a frequency value for determining a frequency of the readout clock CLK?). The average frequency set value is a pulse signal corresponding to the sampling frequency that is derived from a data amount of transmitted data as a value corresponding to the average frequency set value SG 2 of the first embodiment. That is, while the temporary recording average frequency set value SG 3 is a virtual frequency set value of the readout clock CLK, the recording average frequency set value SG 4 is a frequency set value of the readout clock CLK in accordance with actually transmitted sound data.

The selector 14′ selects and output the temporary recording average frequency set value SG 3 or the recording average frequency set value SG 4. This selection is carried out based on signals sent from the microcomputer through the bus. During a period in which no sound data is input, the temporary average frequency set value SG 3 is selected. During a period in which sound data is input, the average frequency set value SG 4 is selected.

The frequency synchronizer 15′ includes a frequency comparing unit 151′ and a clock generator 152′. The frequency comparing unit 151′ outputs a frequency control signal f_ADJ′ based on a frequency difference between the temporary recording average frequency set value SG 3 or recording average frequency set value SG 4 selected by the selector 14′ and the read-in clock CLK′ generated with the clock generator 152′. The frequency control signal f_ADJ′ is a pulse signal the duty ratio of which is changed based on a frequency difference between the temporary recording average frequency set value SG 3 or the recording average frequency set value SG 4 and the readout clock CLK, for example. In addition, if the frequency of the readout clock CLK is higher than the temporary recording average frequency set value SG 3 or the recording average frequency set value SG 4, a high-level period of the pulsed frequency control signal is set short (duty ratio is set low). If the frequency is lower, a high-level period of the pulsed frequency control signal is set long (duty ratio is set high).

The clock generator 152′ is a block generating a read-in clock CLK′ the frequency of which varies depending on the duty ratio of the frequency control signal f_ADJ′, for example. In this embodiment, the clock generator 152′ includes a low-pass filter (LPF) 153′ and a voltage-controlled oscillator (VCO) 154′. The clock generator 152′ generates a DC voltage where the frequency control signal f_ADJ′ is filtered and smoothed with the LPF 153′, and the VCO 154′ generates the readout clock CLK′ of a frequency corresponding to the DC voltage level.

The EPB 16′ reads sound data to the FIFO 18′ to send the sound data to the PC through the protocol converter 11. The FIFO 18′ is a first-in first-out memory operating in sync with a read-in clock CLK, and is a block temporarily storing sound data. The serial/parallel converter 19′ is a block that converts serial data from the ADC 30′ into parallel data to send the parallel data to the FIFO 18′.

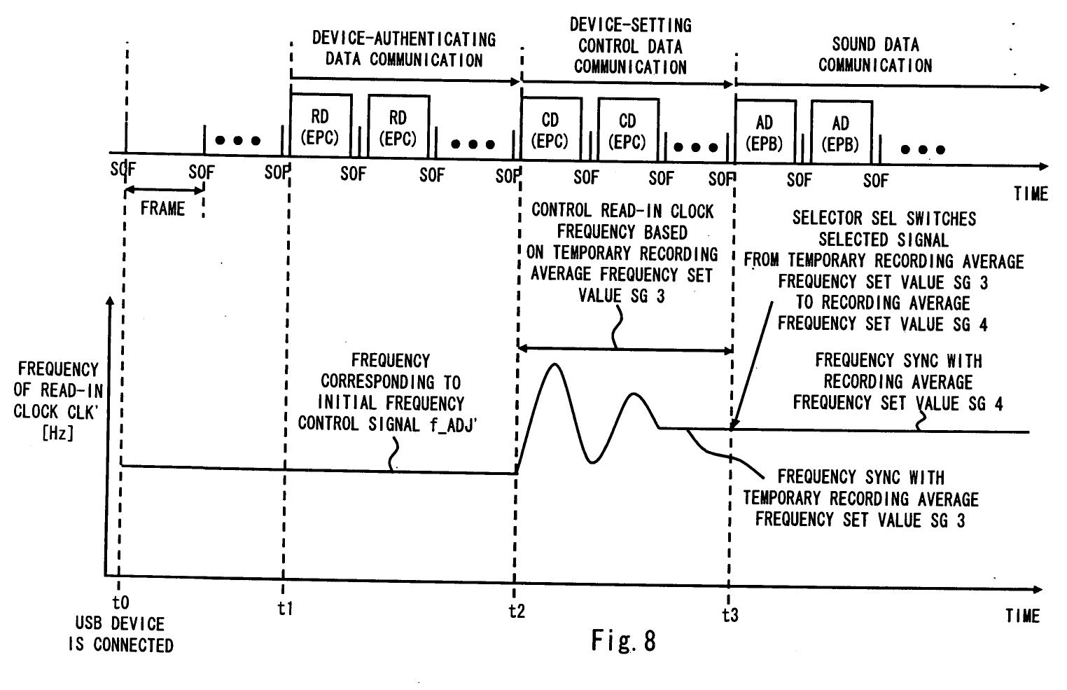

The data synchronizer 10′ of the second embodiment is described in detail below. The reproducing operation of the data synchronizer 10′ is the same as the first embodiment, so description thereof is omitted, and the following description is focused on the recording operation. The recording operation is described with reference to FIG. 8 showing a flow of frames transmitted/received between the PC and the USB device 2 and the change with time in frequency of the read-in clock CLK′.

As shown in FIG. 8, when the PC and the USB device 2 are connected at time t0, several frames including no data are transmitted/received. Thereafter, during the first period (period from time t1 to time t2), the device authenticating control data RD designating the EPC 12 is transmitted/received to authenticate the USB device 2. At this time, the USB device 2 sends information about the sampling frequency adaptive to the device, to the host side. In addition, the frequency of the readout clock CLK corresponds to the initial frequency control signal f_ADJ.

Subsequently, during the second period (period from time t2 to time t3), the PC transmits the device setting control data CD designating the EPC 12 to the USB device 2 for control settings of the USB device 1. Incidentally, in this embodiment, at the start timing in this period, the temporary recording average frequency set value SG 3 is sent from the host to the device. Thus, the USB device 2 makes the frequency of the read-in clock CLK′ sync with the temporary recording average frequency set value SG 4 under the control.

After the completion of control settings of the USB device 2 at time t3, the USB device 2 starts transmitting the sound data to the PC. At this time, the selector 14′ of the data synchronizer 10′ switches the selected signal from the temporary recording average frequency set value SG 3 to the recording average frequency set value GS 4. Further, regarding the way to control the frequency of the read-in clock CLK′, a frequency controlled to be sync with the temporary recording average frequency set value SG 3 in a period from time t2 to time t3 is set as an initial value, and in the third period (from time t3 forward), the frequency is controlled based on the recording average frequency set value SG 4. From time t3 forward, the frequency of the read-in clock CLK′ is controlled to be sync with the recording average frequency set value GS4. Incidentally, it is preferred to finely adjust, from time t3 forward, the frequency of the read-in clock CLK′ based on the second frequency set value representing the sampling frequency of the sound data sent from the USB device 2 to the PC (for example, frequency set value calculated from the memory space of the FIFO 18′) in order to prevent the overflow or under flow of the FIFO 18′.

As understood from the above description, according to the data synchronizer 10′ of the second embodiment, since the read-in clock CLK′ is controlled based on the recording average frequency set value SG 3 prior to the transmission/reception of sound data, after the start of transmission/reception of the sound data, sounds can be recorded and sound data can be transmitted/received with the frequency of the read-in clock CLK′ sync with the recording average frequency set value SG 4 derived from the transmitted sound data.

Incidentally, the present invention is not limited to the above embodiments and may be appropriately modified. For example, the above embodiments describe communications based on the USB standards. However, the present invention is not limited to the communications based on the USB standards but is applicable to communications of data obtained by digitalizing analog data with a predetermined sampling frequency if its configuration is changed as appropriate.

The above embodiments describe an example where the temporary average frequency set value SG 1 and the average frequency set value SG 2 are pulse signals, and the frequency comparing unit 14 compares frequencies of the readout clock CLK and the pulse signals. This configuration may be changed such that sound data amounts of the temporary average frequency set value SG 1 and average frequency set value SG 2 are expressed in bytes as data amounts A and B, respectively, and a read data amount C corresponding to the frequency of the readout clock CLK and expressed in bytes is calculated; during a period in which no sound data is input, the frequency comparing unit 14 compares the data amount A with the data amount C, and during a period in which sound data is input, the frequency comparing unit 14 compares the data amount B with the data amount C; and the frequency of the readout clock CLK is adjusted based on the frequency difference.

It is apparent that the present invention is not limited to the above embodiment that may be modified and changed without departing from the scope and spirit of the invention.

What is claimed is:

1. A data synchronizer for outputting data with a readout clock frequency sync with input data or receiving data with a read-in clock frequency sync with output data, comprising:
a frequency synchronizer controlling a frequency of the readout clock or a frequency of the read-in clock based on an input data amount or output data amount per unit time,
the frequency synchronizer controlling the frequency of the readout clock or the frequency of the read-in clock based on a first frequency set value that is preset, before the input data is input or the output data is output.

2. The data synchronizer according to claim 1, wherein the first frequency set value is a value previously set in the data synchronizer or a value supplied from the outside of the data synchronizer.

3. The data synchronizer according to claim 1, wherein the first frequency set value is set such that a difference from a second frequency set value derived from the input data or the output data falls within a predetermined range.

4. The data synchronizer according to claim 1, wherein the frequency synchronizer compares the first frequency set value, or a second frequency set value derived from the input data or the output data with a frequency value of the readout clock or the read-in clock to control the frequency of the readout clock or the frequency of the read-in clock.

5. The data synchronizer according to claim 1, wherein the frequency synchronizer includes: a first period in which the frequency of the readout clock or the frequency of the read-in clock is controlled based on a set value that is preset in the data synchronizer; a second period in which the frequency of the readout clock or the frequency of the read-in clock is controlled based on the first frequency set value that is set under external control of the data synchronizer; and a third period in which the frequency of the readout clock or the frequency of the read-in clock is controlled based on a second frequency set value that is set based on a data amount per unit time of the input data or the output data.

6. The data synchronizer according to claim 1, further comprising:
a storage unit storing the input data or the output data,
the data synchronizer reading the input data from the storage unit in sync with the readout clock or writing the output data to the storage unit in sync with the read-in clock.

7. A clock frequency controlling method of a clock frequency of a data synchronizer that outputs data with a readout clock frequency sync with input data or receives data with a read-in clock frequency sync with output data, comprising:
controlling a frequency of the readout clock or a frequency of the read-in clock based on an input data amount or output data amount per unit time; and
controlling the frequency of the readout clock or the frequency of the read-in clock based on a first frequency set value that is preset, before the input data is input.

8. The clock frequency controlling method according to claim 7, wherein the first frequency set value is a value previously set in the data synchronizer or a value supplied from the outside of the data synchronizer.

9. The clock frequency controlling method according to claim 7, wherein the first frequency set value is set such that a difference from a second frequency set value derived from the input data or the output data falls within a predetermined range.

10. The clock frequency controlling method according to claim 7, further comprising:
comparing the first frequency set value, or a second frequency set value derived from the input data or the output data with a frequency value of the readout clock or the read-in clock to control the frequency of the readout clock or the frequency of the read-in clock.

11. The clock frequency controlling method according to claim 7, wherein the data synchronizer includes: a first period in which the frequency of the readout clock or the frequency of the read-in clock is controlled based on a set value that is preset in the data synchronizer; a second period in which the frequency of the readout clock or the frequency of the read-in clock is controlled based on the first frequency set value that is set under external control of the data synchronizer; and a third period in which the frequency of the readout clock or the frequency of the read-in clock is controlled based on a second frequency set value that is set based on a data amount per unit time of the input data or the output data.

12. The clock frequency controlling method according to claim 7, wherein the data synchronizer includes a storage unit storing the input data or the output data, the data synchronizer reading the input data from the storage unit in sync with the readout clock or writing the output data to the storage unit in sync with the read-in clock.

13. A data converter, comprising:
a terminal transmitting/receiving data to/from an external device;
a first converter converting input data input from the terminal or a second converter converting an analog signal into output data output from the terminal; and
a data synchronizer outputting the received input data to the first converter in sync with a readout clock, or receiving data while synchronizing a read-in clock from the second converter with the output data,
the data synchronizer including:
a frequency synchronizer controlling a frequency of the readout clock or a frequency of the read-in clock based on an input data amount or output data amount per unit time,
the frequency synchronizer controlling the frequency of the readout clock or the frequency of the read-in clock based on a first frequency set value that is preset, before the input data is input or the output data is output.

14. The data converter according to claim 13, wherein the first frequency set value is a value previously set in the data synchronizer or a value supplied from the outside of the data synchronizer.

15. The data converter according to claim 13, wherein the first frequency set value is set such that a difference from a second frequency set value derived from the input data or the output data falls within a predetermined range.

16. The data converter according to claim 13, wherein the frequency synchronizer compares the first frequency set value, or a second frequency set value derived from the input data or the output data with a frequency value of the readout clock or the read-in clock to control the frequency of the readout clock or the frequency of the read-in clock.

17. The data converter according to claim 13, wherein the frequency synchronizer includes: a first period in which the frequency of the readout clock or the frequency of the read-in clock is controlled based on a set value that is preset in the data synchronizer; a second period in which the frequency of the readout clock or the frequency of the read-in clock is controlled based on the first frequency set value that is set under external control of the data synchronizer; and a third period in which the frequency of the readout clock or the frequency of the read-in clock is controlled based on a second frequency set value that is set based on a data amount per unit time of the input data or the output data.

18. The data converter according to claim 13, further comprising:
a storage unit storing the input data or the output data,
the data converter reading the input data from the storage unit in sync with the readout clock or writing the output data to the storage unit in sync with the read-in clock.
